(19) United States
(12) Patent Application Publication
(10) Pub. No.: US 2019/0122455 A1
(43) Pub. Date: Apr. 25, 2019

(54) AERIAL RADIO-FREQUENCY IDENTIFICATION (RFID) TRACKING AND DATA COLLECTION SYSTEM

(71) Applicant: TUNNEL RADIO OF AMERICA, INC., Corvallis, OR (US)

(72) Inventors: Timothy D. Howard, Albany, OR (US); Craig S. Pataky, Cottage Grove, OR (US)

(21) Appl. No.: 16/164,684

(22) Filed: Oct. 18, 2018

Related U.S. Application Data
(60) Provisional application No. 62/574,673, filed on Oct. 19, 2017.

(51) Int. Cl. G07C 5/08; G05D 1/02; G05D 1/10; B64C 39/02

(52) U.S. Cl. CPC G07C 5/085; G05D 1/0202; B64C 2201/122; B64C 39/024; G05D 1/102

(57) ABSTRACT

An aerial RFID tracking and data collection system is described herein that includes a server having a communication interface designed to send and receive data from an unmanned aerial vehicle (UAV). The server is also designed to receive a data bundle including environmental sensor data and an RFID tag identifier from the UAV, where the RFID tag identifier and temperature sensor data in the environmental sensor data are generated by a land-based RFID device in wireless communication with the UAV. The server is also designed to generate a graphical user interface including a representation of the environmental sensor data.

### CROSS REFERENCE TO RELATED APPLICATION

The present application claims priority to U.S. Provisional Application No. 62/574,673, entitled “AERIAL RADIO-FREQUENCY IDENTIFICATION (RFID) TRACKING AND DATA COLLECTION SYSTEM”, filed on Oct. 19, 2017. The entire contents of the above-listed application are hereby incorporated by reference for all purposes.

### BACKGROUND

The use of unmanned aerial vehicles (UAVs) in different fields, such as aerial videography as well as military endeavors, has rapidly progressed due to advances in flight controllers and autopilot software.

However, the use of UAV's has been slower to catch on in other sectors. For instance, in emergency response situations such as in fire response, search and rescue, law enforcement, or other situations involving first responders, difficulties often arise when coordinating large teams of people. Team coordinators typically have poor visibility of team members and often rely on slow, inaccurate verbal information to make critical decisions. Resultantly, verbal misunderstandings and/or inabilities to ascertain and disseminate critical information increases first responders' exposure to risk. For instance, on scene communication deficiencies may cause first responders to become lost, travel into dangerous areas, etc.

Previous approaches for providing wireless communication to first responders have made use of dedicated radio bands. However, these radio bands only provide two-way voice communication and do not enable situational data such as maps, environmental data, etc., to be transferred between first responders. Therefore, first responders may not have pertinent information readily accessible while emergency situations unfold. Ill-informed decision making may stem from this information deficiency. Prior communication systems, therefore, fail to provide first responders with accurate and expedient information during an emergency.

### SUMMARY

To address at least some of the aforementioned problems the inventors developed an aerial radio-frequency identification (RFID) tracking and data collection system providing fast and efficient data transfer between first responders, during emergency situations. The system may include a plurality of land-based RFID devices with integrated RFID transmitter tags and environmental sensors, such as temperature sensors. The system further includes an unmanned aerial vehicle (UAV) with an RFID scanner designed to receive RFID tag and sensor data from the land-based RFID devices. The UAV may append location data to the RFID tag data and sensor data. The UAV may then transmit the tag information, sensor data, and location data via the communication head to a server. After receiving the information the server may generate maps with locations of the land-based RFID devices. The maps may indicate vertical coordinates of the RFID devices, in one example. The vertical position of first responders may be used to differentiate between the locations of multiple first responders in buildings and other tall structures with floors, for instance. The sensor data may also be used to generate dynamic map overlays indicating gas levels, temperature levels, hazardous areas, etc. In this way, sensor data is leveraged to provide critical information to incident commanders and/or other team coordinators, thereby allowing the commanders to make more informed decisions during emergency situations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example operating environment for an aerial radio-frequency identification (RFID) tracking and data collection system including an unmanned aerial vehicle (UAV) equipped with an RFID receiver, RFID devices, a communication head, and a server.

FIG. 2 schematically shows examples of the UAV with an integrated RFID receiver and RFID devices included in the system, shown in FIG. 1.

FIG. 3 schematically shows an example communication head and server receiving a data bundle from the UAV, shown in FIGS. 1 and 2.

FIG. 4 shows a method for operating an aerial RFID tracking and data collection system.

FIG. 5 shows a method for operating a UAV in an aerial RFID tracking and data collection system.

FIG. 6 shows another method for operating an aerial RFID tracking and data collection system.

FIG. 7 illustrates an example of a display presenting a graphical user interface that may be included in the RFID tracking and data collection system, shown in FIGS. 1-3.

### DETAILED DESCRIPTION

Systems and methods that provide rapid data sharing capabilities during emergencies or other situations are described herein. One approach for providing efficient data transfer between first responders is an aerial radio-frequency identification (RFID) tracking and data collection system including an unmanned aerial vehicle (UAV) equipped with an RFID receiver. The system may further include a plurality of RFID devices including active RFID transmitter tags, temperature sensors, and/or other environmental sensors that may be affixed to first responders and/or objects such as vehicles, buildings, etc.

During an emergency, for example, the UAV is programmed to fly around scanning for the land-based RFID devices. Once the RFID signals are picked up by the UAV, the UAV may add time and location information to the data sent from the RFID devices (i.e., tag data, environmental sensor data, etc.). The UAV may also have on-board environmental sensors, such as gas sensors. In such an example, this additional sensor data may be bundled with the RFID tag data sent from the RFID device. After appending the time, location data (e.g., RFID device location), and sensor data to the tag data the UAV may send the bundled data to a server through a communication head. In turn, the server may store the tag information, location information, and environmental sensor information for downstream processing.

At the server the bundled data may be used to generate maps and/or other graphical representations of the location data and environmental sensor data that provide accurate, and in some cases real-time, views of first responder locations. As described herein, real-time communication refers to live communication occurring with transmission delays less than a threshold value (e.g., 2 seconds, 1 second, 100 milliseconds, etc.). In some examples, the real time communication data may not be stored between transmission and reception. However, in other examples, a certain amount of data storage may take place during the communication scheme. However, it will be appreciated that data may not be transferred in real-time through the at least portions of the system described herein, in some examples. The server may also use the bundled data to generate map overlays such as temperature and gas level overlays. The maps may be dynamically updated as the UAV gathers additional data, thereby providing up-to-date maps of an emergency scene. Armed with this data incident commanders, team leaders, etc., can make more informed decisions while an emergency unfolds. As a result, the team leaders may more effectively coordinate on-site first responders. For instance, the maps and overlays may be helpful when guiding first responders through low visibility environments, such as smoky building. The maps and overlays may also enable incident commanders to more accurately predict the direction a fire is likely to spread, for example. As a result, the first responder's situational awareness may be further increased.

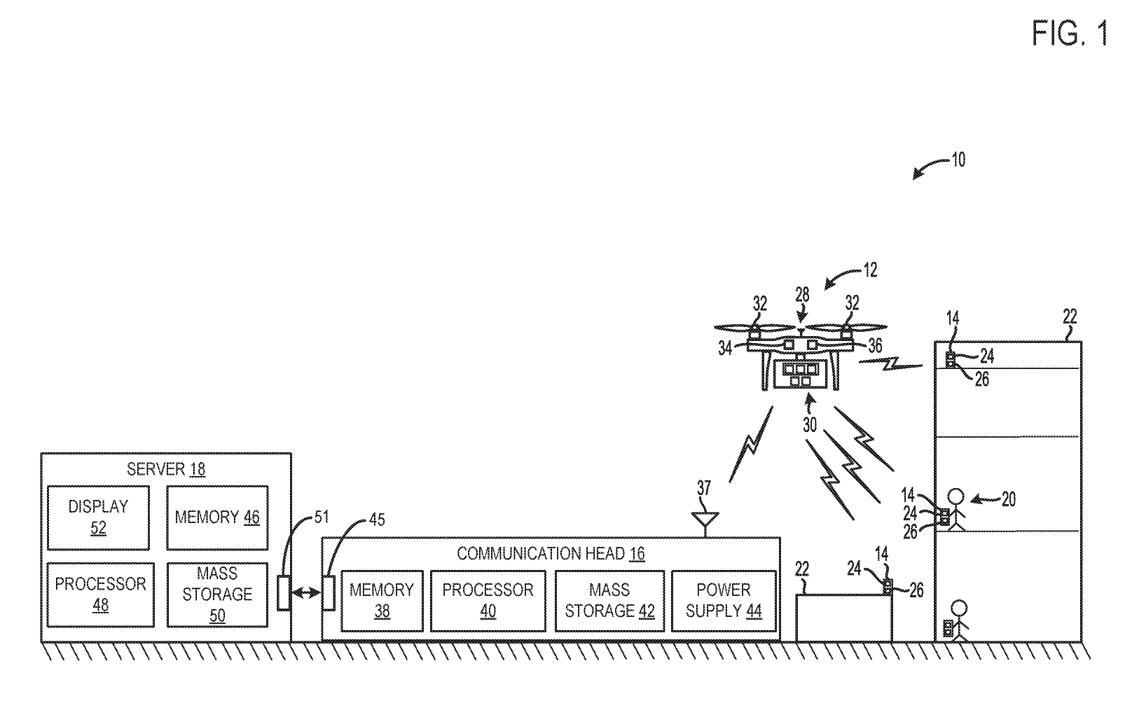

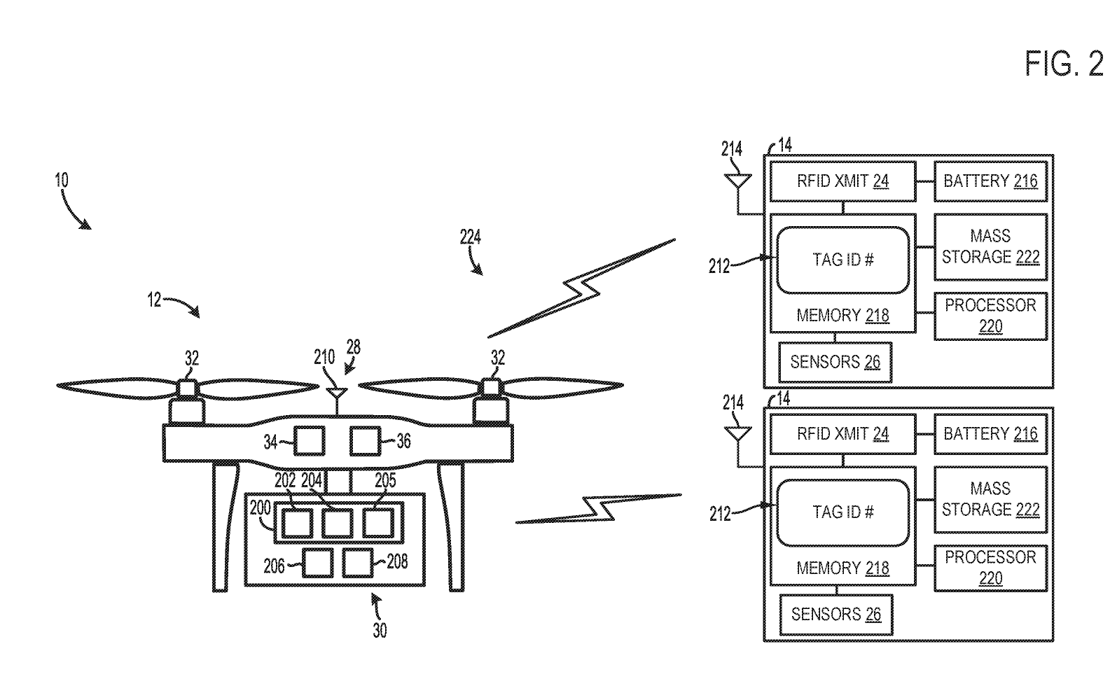

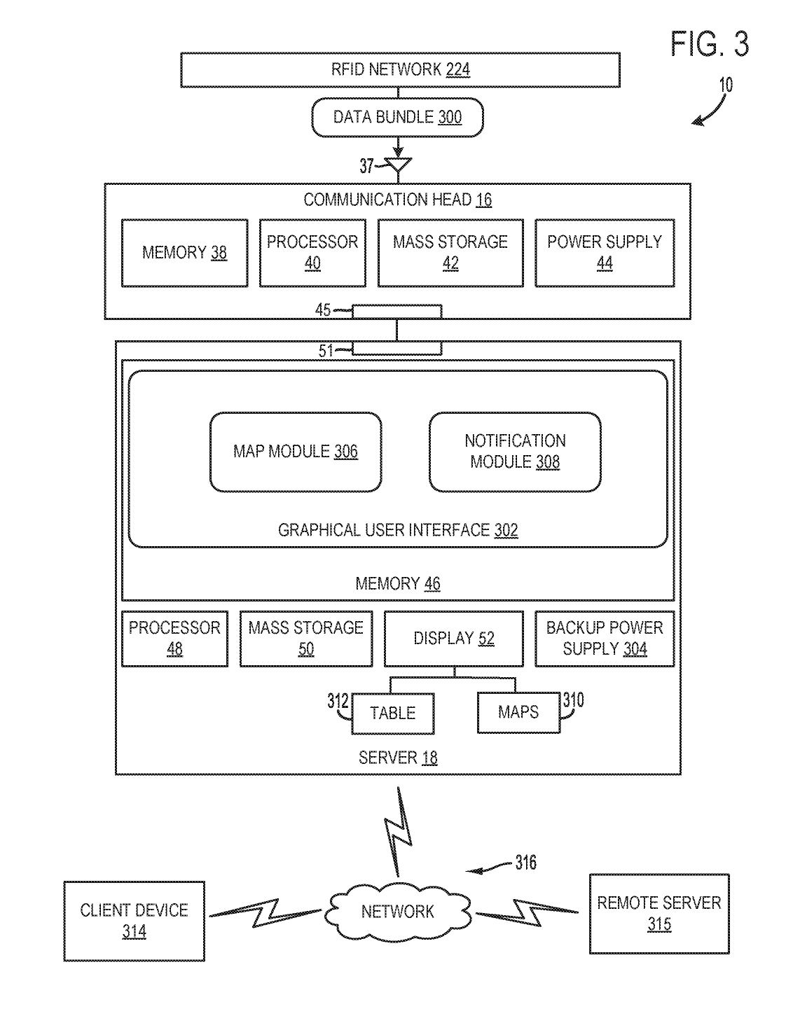

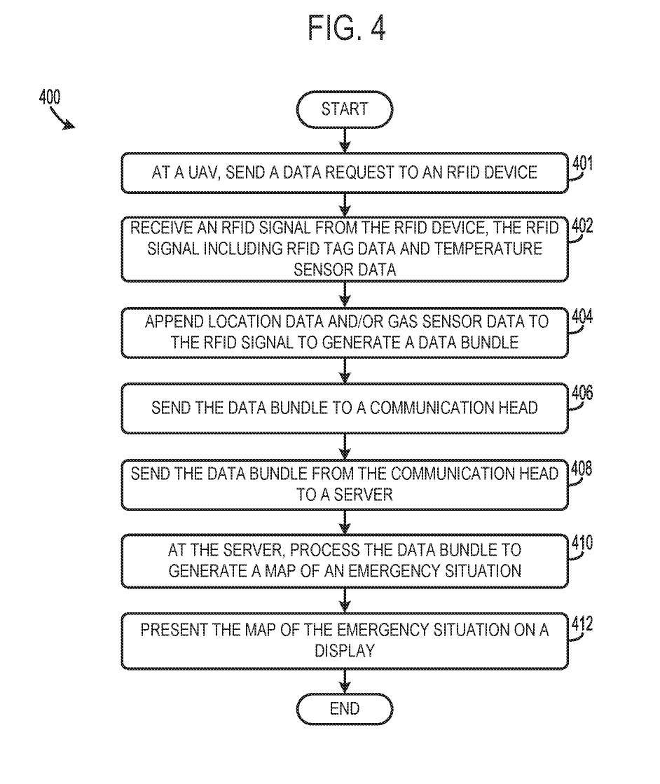

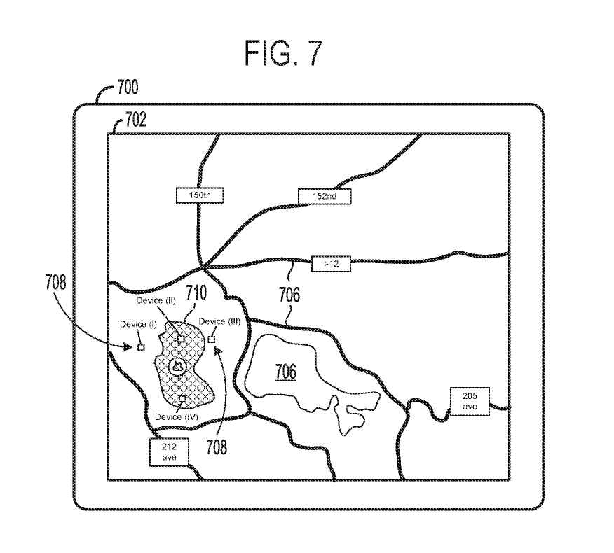

FIG. 1 illustrates an example of an aerial RFID tracking and data collection system 10 in an example operating environment. The aerial RFID tracking and data collection system is further illustrated in FIGS. 2-3 which should be referenced in combination with FIG. 1. In this regard, FIG. 2 schematically shows an example UAV including an RFID receiver and example RFID devices and FIG. 3 schematically shows a server and communication head for use in the aerial RFID tracking and data collection system. For further illustrative purposes, FIGS. 4-6 show methods for managing data and controlling a UAV in an aerial RFID tracking and data collection system. FIG. 7 shows an example of a graphical user interface that may be generate by a server in the aerial RFID tracking and data collection system, shown in FIGS. 1-3.

Aspects of this disclosure will now be described by example and with reference to the illustrated embodiments. Components and other elements that may be substantially the same in one or more embodiments are identified coordinately and are described with minimal repetition. It will be noted, however, that elements identified coordinately may also differ to some degree. Furthermore, the size, shape, and/or configurations of the various components of the aerial RFID tracking and data collection system are provided to ease understanding and are not intended to be technically precise.

FIG. 1 shows a depiction of an aerial RFID tracking and data collection system 10 in an example operating environment. Although, the operating environment is shown in the context of a firefighting scenario, it will be appreciated that aerial RFID tracking and data collection system 10 may be applied to a number of fields including, but not limited to, first response, wildland firefighting, search and rescue, academic research, construction, recreation, etc.

The aerial RFID tracking and data collection system 10 is configured to establish a wireless RFID network between a UAV 12, land-based RFID devices 14, a communication head 16, and a server 18.

The RFID network may be configured to use one or more frequencies in a mobile radio band which may have a frequency range of approximately 144-2400 MHz, which may permit the system to operate using an existing or new commercial two-way radio network. This may provide rapid deployment and extensibility of the aerial RFID tracking and data collection system.

In the operating environment shown in FIG. 1, RFID devices 14 are carried or otherwise affixed to first responders 20 (e.g., firefighters, police, emergency medical technicians (EMTs), etc.,) as well as objects 22 (e.g., vehicles, buildings, light posts, etc.). For instance, the land-based RFID devices 14 may be integrated into equipment, clothing, etc., of the first responders, enabling space saving deployment of the devices, in one example. However, in other examples, the land-based RFID devices 14 may take the form of handheld computing devices, wearable computing devices (e.g., watch or headset), etc.

The land-based RFID devices 14 include RFID transmitters 24 and environmental sensors 26. The environmental sensors 26 are designed to report ambient conditions. Thus, the land-based RFID devices 14 may generate sensor data bundled with RFID tag identifier data, of instance. The sensor data and RFID tag identifier data may then be wirelessly transferred to other devices in the aerial RFID tracking and data collection system 10. Thus, the sensor data and the tag identifier data may be transmitted in the form of signals (e.g., wireless signals). In one example, the sensor signals and the RFID tag identifier may be packaged in a data bundle, discussed in greater detail herein. The environmental sensors 26 may include a temperature sensor designed to generate temperature sensor data, a gas sensor (e.g., oxygen sensor, carbon dioxide sensor, etc.,) designed to generate gas sensor data, etc.

The land-based RFID devices 14 may include additional sensors for measuring barometric pressure, humidity, and hazardous gases, as examples, and other components discussed in greater detail herein with regard to FIG. 2.

The land-based RFID devices 14 are configured to wirelessly communicate with the UAV 12 employing RFID receivers 28 designed to scan for RFID tag signals and request sensor data generated by the land-based RFID devices 14. For instance, the UAV 12 may be designed to scan for RFID devices in the range of 25-1000 ft. The RFID tag scanning may be periodically implemented, in one instance. However, in other examples the scanning may be continuously performed or may be performed based on trigger events (e.g., user commands, geographical zones, etc.). To enable long range scanning the RFID receiver may include high gain antennas, low noise amplifiers, etc.

The UAV 12 is equipped with a sensor array 30 along with other on-board components for processing and transmitting sensor data. The contents of sensor array 30 and other components in the UAV 12 are discussed in greater detail herein with regard to FIG. 2.

The UAV 12 is also equipped with rotors 32 and/or with one or more propellers, in the context of a fixed wing UAV. The rotors 32 enable the UAV 12 to fly around a targeted emergency zone such as an area around a fire or other crisis. The rotors 32 may receive energy (e.g., a rotational input) from a motor 34. In turn, the motor 34 receives energy from an energy storage device 36 (e.g., battery, fuel cell, etc.). Additionally or alternatively, an internal combustion engine may provide rotational input to the rotors 32. A generator may also be installed in the UAV 12 to provide extended flight time, either by in-flight charging of batteries or as a primary energy source.

Once wireless communication has been established between the land-based RFID devices 14 and the UAV 12 the UAV may gather the tag and temperature data from the land-based RFID devices 14. Specifically in one example, responsive to reception of a data request from the UAV 12, the land-based RFID devices 14 may send tag and sensor data back to the UAV. After the UAV gathers the tag and temperature data the UAV may append location information, time data, and/or environmental sensor data (e.g., additional temperature sensor data, gas sensor data, etc.,) to a data bundle sent to the server 18 from the UAV. In this way, additionally data may be added to the data bundle sent to the server, expanding the system's data gathering capabilities. Consequently, first responders and/or other personnel may be provided with greater amounts of situational information during an emergency, for example.

The location information appended by the UAV 12 to the data bundle may be determined based on location coordinates (e.g., GPS coordinates) of the UAV 12 as well as the signal strength and direction of the RFID transmitter tags in the land-based RFID devices, in one example. The environmental sensor data (e.g., gas sensor data) may be generated by sensors on-board the UAV, discussed in greater detail herein. However, in other examples, the locations of the RFID devices and/or the gas sensor data may be generated locally at each RFID device.

Additionally, the UAV 12 is configured to fly around a region according to a flight path. The flight path may be preselected prior to UAV deployment or may be generated subsequent to deployment based on inputs such as control signals from a ground operator, sensor data, etc. For instance, a flight operator may control the flight path in near real-time. However, in other examples the UAV may be at least semi-autonomous. The UAV 12 may autonomously scan a defined area, but use artificial intelligence (AI) to shift into different scan patterns or return to a manual mode, in one example. The flight path may be at least partially stored on-board the UAV and/or may be transmitted to the UAV from the communication head 16.

The UAV 12 is configured to wirelessly communicate with the communication head 16. Thus, the communication head 16 may act as a communication gateway through which UAV data is routed. The communication head 16 includes a head antenna 37 designed to send and receive radio signals to/from the UAV 12. The communication head 16 also includes memory 38, a processor 40, mass storage 42, and a power supply 44. The memory 38 may store instructions executable by the processor 40 to carry out the methods, functions, etc., described herein. It will be appreciated that the UAV 12 and the communication head 16 may wirelessly communicate via numerous suitable communications protocols, technologies, etc., such as mobile radio bands, cellular data services, etc.

The communication head 16 is in communication (e.g., wired and/or wireless communication) with the server 18. The communication head 16 may therefore relay RFID tag information, temperature sensor data, gas sensor data, etc., to the server 18 from the UAV 12 and the RFID devices 14. The communication head 16 may include a communication interface 45 facilitating wired and/or wireless electronic communication between the communication head 16 and the server 18. The communication interface 45 therefore may include hardware, software, cables, antennas, etc. Likewise, the server 18 may include a communication interface 53 allowing for wired and/or wireless electronic communication with the communication head 16. The communication interface 53 may include also include hardware, software, cables, etc., enabling the wired/wireless electronic communication.

The server 18 includes memory 46, a processor 48, mass storage 50, and a display 52 to implement the data processing features described herein. The server 18 includes additional hardware and software components that are discussed in detail herein with regard to FIG. 3.

FIG. 2 shows a detailed illustration of the UAV 12 and the RFID devices 14 in the aerial RFID tracking and data collection system 10. As previously mentioned, the UAV 12 includes the motor 34, energy storage device 36, and rotors 32. The rotors 32 may be operated to maintain the UAV on a predetermined flight path. The flight path may be stored locally and/or transmitted to the UAV from the communication head 16 and server 18, shown in FIG. 1. It will also be appreciated that the UAV's flight path may be dynamically adjusted based on sensor readings and/or other pertinent data inputs generated by the UAV and/or sent to the UAV from the RFID devices, communication head, server, etc.

The UAV 12 also includes a controller 200 having a processor 202, memory 204, and mass storage 205. The controller 200 receives sensor data from the sensor array 30. The sensor array 30 may include a gas sensor 206 (e.g., oxygen sensor, carbon dioxide sensor, carbon monoxide sensor, methane sensor, barometric pressure sensor, temperature sensor, humidity sensor, etc.). Additionally, the UAV 12 is equipped with a location device 208 (e.g., global positioning system (GPS) receiver) configured to generate coordinate data corresponding to a position of the UAV as well as the RFID devices. The coordinate data may include horizontal (e.g., lateral and longitudinal) and/or vertical coordinates, in one example. For instance, the coordinate data may include a latitude and longitude and a height or depth value. However, numerous schemes representing RFID device coordinates and/or UAV coordinates have been envisioned. The UAV 12 may use directionally focused antennas and/or barometric pressure sensors on the UAV and/or the RFID devices 14 to determine the coordinates (e.g., horizontal and/or vertical coordinates) of the RFID device. In this way, the UAV may be configured to determine a vertical height of the RFID devices along with a horizontal position of the device. In one specific example, the vertical coordinate may be expressed as a building floor value. Building floor data may be particularly useful in emergency response scenarios where multi-story buildings are involved. In this way, first responders and/or other personnel can be provided with more granular data, further increasing the amount of pertinent data available to the first responders.

The controller 200 may also be configured to control various actuators in the UAV such as the rotors 32, cameras, cargo hooks, moveable antennas, and sensors, etc. Furthermore, the memory may store instructions, routines, etc., executable by the processor to implement the UAV functions described herein.

FIG. 2 also shows the RFID receiver 28 including an antenna 210 designed to receive radio signals. In some embodiments, the antenna 210 may receive transmissions at one or more frequencies within a range of approximately 315 MHz-2.4 GHz. Further, in some embodiments, antenna 210 may be configured as a highly focused, long-range receiver to capture transmissions from distantly located RFID devices 14. One non-limiting RFID receiver may receive an RFID transmission from an RFID device located up to 400 feet away. The RFID receiver 28 may employ the use of a variety of antenna types including, but not limited to, moveable antennas, “Yagi” multi-element antennas, loop antennas, fractal antennas, etc.

The UAV 12 is configured to scan selected regions for RFID signals generated by the RFID transmitter 24 in the RFID devices 14. Thus, the UAV 12 may receive data such as tag data and environmental sensor data from the RFID devices 14. The tag data may include an RFID tag identifier. The UAV 12 may append data to the data gathered from the RFID devices 14, such as location data, time data, and/or environmental sensor data (e.g., gas sensor data). In this way, the RFID devices 14 and the UAV 12 are jointly operated to gather data in a coordinated manner. The bundled data may then be transferred to back-end components (e.g., the communication head and the server) for further processing.

The UAV 12 may also send data to the RFID devices 14 such as setting changes, alerts, etc. Therefore, an RFID network 224 may be established between the RFID devices 14 and the UAV 12 to enable data to be transferred between the UAV 12 and the RFID devices 14.

The RFID transmitters 24 in the RFID devices 14 is coupled to RFID tags 212 and device antennas 214. The RFID tags 212 may include alphanumeric identifiers (e.g., unique alphanumeric identifiers) enabling the RFID device to be recognized during downstream processing. Thus, the RFID tags 212 may be designed to generate RFID tag identifiers and the RFID transmitters 24 may be designed to transmit the identifiers along with other data such as data from the environmental sensors 26. The RFID tags 212 may be stored in memory 218 connected to a processor 220. Additionally, metadata may also be bundled with the identifier, in some instances. Further, in some embodiments, RFID tag 212 may encrypt tag information so that data is securely transferred to the UAV.

RFID transmitter 24 may be any suitable radio transmitter. In some examples, RFID transmitter 24 may transmit at one or more frequencies within a range of approximately 315 MHz-2.4 GHz. In another example, the RFID transmitter 24 may be configured to transmit tag information in multiple bursts at regular intervals to enable the device to conserve energy.

In the example shown in FIG. 2, RFID devices 14 also include batteries 216. Additionally or alternatively, in some embodiments, another suitable power supply may be included in RFID devices 14. For example, a solar panel and/or suitable energy-harvesting device may be included in RFID device 14. Further, in some examples, the RFID devices 14 may include a mass storage device 222 for storing tag information when RFID tag 212 is unpowered.

FIG. 3 shows a detailed illustration of a back-end portion of the aerial RFID tracking and data collection system 10 including the communication head 16 and the server 18.

As shown, communication head 16 interfaces with the RFID network 224 via the head antenna 37. As previously discussed, the RFID radio network may be established between RFID devices 14 and the UAV 12, shown in FIGS. 1 and 2. As such, the UAV 12 and RFID devices 14 shown in FIG. 2, may communicate with one another to generate data bundle 300 that includes RFID tag data, location data, and/or environmental sensor data (e.g., gas data, temperature data, etc.). Thus, the data bundle 300 may be received by the communication head 16 in the form of radio signals. A data bundle as described herein a data bundle include any aggregation, package, of one or more types of data such as sensor data, location data, RFID tag data, etc. Additionally, in one example, the UAV 12 prior to sending the bundle to the communication head 16 the UAV may append location data (e.g., a vertical coordinate and horizontal coordinates (e.g., latitude and longitude)) to the sensor data to form the data bundle. It will also be appreciated that the communication head 16 may send data such as maps, alerts, etc., to targeted RFID devices in the RFID network 224.

The data bundle 300 is transferred to the communication head 16 for downstream processing. As previously discussed, the communication head 16 includes memory 38, the processor 40, mass storage 42, and the power supply 44 for processing the data bundle as well as implementing other features described herein. The communication interfaces 45 and 51 are again shown in FIG. 3.

Furthermore, the server 18 is in communication (e.g., wired and/or wireless communication) with the communication head 16. In some examples, communication head 16 may communicate with the server 18 via a serial and/or universal serial bus (USB) connection. Additionally or alternatively, in some embodiments, communication head 16 may communicate with the server 18 via a wireless network connection and/or an Ethernet network connection. For example, in one scenario, an Internet Protocol (IP) to serial interface converter may be used for communication. In another scenario, an RS-232 to RS-485 converter may be used for communication. Thus, it will be appreciated that any suitable communication scheme may be used to enable data transfer between the communication head 16 and server 18 within the scope of the present disclosure.

After receiving the data bundle 300 from the RFID network 224 the communication head 16 may transfer the data bundle to the server 18. The server 18 facilitates local control and configuration of the aerial RFID tracking and data collection system 10 via a graphical user interface (GUI) 302, as described in more detail below. In some embodiments, the server 18 may regularly transmit a polling command to the UAV 12 to instruct UAV 12, shown in FIG. 2, to transmit stored data (e.g., a data bundle). However, it will be appreciated that other suitable transmission schemes may be employed. For example, the server 18 may receive transmissions from the UAV 12, shown in FIG. 2, in real time, at predetermined intervals, etc.

As illustrated, the server 18 includes memory 46, processor 48, mass storage 50, and display 52. In some embodiments, the server 18 may include a backup power supply 304, which may permit continued operation of the server 18 during a power failure condition.

The user interface 302 is stored in the memory 46 and enables emergency responders, incident commanders, and/or other personnel to interact with maps, notifications, and other situational information generated by the server 18. Various modules are provided within the user interface such as a map module 306 and a notification module 308. The modules described herein may include software and/or hardware components. As such, the modules may include instructions stored in the memory 46 that are executable by the processor 50. It will also be appreciated that the other features of the server may 18 be stored as instructions in memory. The map module 306 may be configured to generate a 2-dimensional or 3-dimensional map of an emergency including the locations of first responders carrying the RFID devices. The locations of the RFID devices may be ascertained via the UAV 12, shown in FIG. 3, in one example. For instance, the UAV may use a geographical location device (e.g., Global Positioning System (GPS) receiver) onboard the UAV along with the strength, directionality, etc., of the RFID device signals. However, numerous suitable techniques for ascertaining the location of the RFID devices has been envisioned. For instance, the RFID device may additionally or alternatively include geographical location devices (e.g., GPS receivers). The locations of the first responders may include horizontal as well as vertical coordinates. For instance, a building floor corresponding to a first responder may be visually indicated along with a latitude and longitude. In this way, first responders on different floor levels can be easily distinguished during an emergency situation.

Additionally, the server may generate dynamic heat and gas maps during an emergency situation. For instance, the heat and gas maps may be dynamically updated based on a series of gas samples (e.g., real-time or near real-time sensor samples) from the gas sensor onboard the UAV and/or from a series of temperature samples (e.g., real-time or near real-time temperature samples) from the temperature sensors in the RFID devices. The heat and gas maps may be provided as overlays on the map of the emergency scene, in some examples. Still further, in one example, the server may compare readings from two or more environmental sensors to generate dynamic map overlays. For example, temperature and gas data gathered from the UAVs and RFID devices may be compared to ascertain high-risk areas. For instance, if both a temperature level and a carbon monoxide (CO) level exceed a threshold value in a region, the region may be deemed a high-risk area. In other examples, a high-risk area may be ascertained when a temperature level exceeds a threshold value, a gas concentration exceeds a threshold value, or both a temperature level and a gas concentration exceed a threshold value. In yet another example, temperature data from multiple RFID devices may be compared to determine temperature gradients in a building or other geographical locations.

The notification module 308 may be configured to generate alerts that may be relayed to the RFID devices through the UAV. The alerts may trigger audio, visual, haptic, combinations thereof, etc., warning on-board the RFID devices. Furthermore, the alerts may be generated by the server 18 based environmental data gathered on scene by the UAVs and the RFID devices or may be generated locally at the RFID devices. For instance, alerts may be sent to RFID devices deemed to be in high-risk zones. In another example, alerts may be send to an RFID device when it is determined that the temperature around the RFID device exceeds a threshold value (e.g., 130° F., 140° F., 150° F., 200° F., etc.). In this way, first responders may be quickly alerted when their safety may be compromised.

The server 18 also includes the display 52 configured to present graphical data generated by the user interface 302 such as maps 310, tables 312, etc. Further, in some embodiments, the server 18 may also be connected to a client device 314 (e.g., mobile computing device) and/or remote server 315 over a network 316 (e.g., the Internet, a wide area network, virtual private network, etc.). The server 18 may send the maps and other pertinent data to the client device 314 and remote server 315. In this way, the maps and other situational information may be more widely disseminated through established networks, if desired.

In another example, the communication head 16 and the server 18 may form a combined unit (e.g., user interface unit) that is readily accessible by a team coordinator. In such an example, the unit may have common housing enclosing shared components (e.g., memory, processor, etc.). The user interface unit may be portable, in one instance, to enable the unit to be deployed in a mobile command scenario. However, numerous configurations of the communication head 16 and the server 18 have been envisioned.

FIG. 4 shows a method 400 for operating an aerial RFID tracking and data collection system. The method may be implemented by the aerial RFID tracking and data collection system and corresponding devices, components, etc., described above with regard to FIGS. 1-3 or may be implemented by other suitable aerial RFID tracking and data collection systems. It will also be appreciated that the method 400 as well as the other methods described herein may be stored in non-transitory memory as instructions executable by a processor.

At 401 the method includes at a UAV, sending a data request (e.g., sensor and tag data request) to an RFID device. Next, at 402 the method includes, at the UAV, receiving an RFID signal from the RFID device, the RFID signal including RFID tag data and temperature sensor data. It will be appreciated that the RFID device may send the tag and sensor data to the UAV in response to receiving the data request from the UAV. In this way, the UAV collects situational data from land-based RFID devices. In other examples, additional or alternative environmental sensor data gathered via the RFID device may be received by the UAV from the RFID device such as gas sensor data, location data, first responder biomedical data (e.g., pulse rate, body temperature, etc.), etc.

Next at 404 the method includes, at the UAV, appending location data and/or gas sensor data to the RFID signal to generate a data bundle. As such, data gathered by the UAV and the land-based RFID device may be efficiently packaged for downstream processing.

At 406 the method includes sending the data bundle from the UAV to the communication head. The data bundle may be efficiently sent across a wireless network established between the communication head, the UAV, and the RFID devices.

At 408 the method includes sending the data bundle from the communication head to a server. At 410 the method includes, at the server, processing the data bundle to generate a map (e.g., a dynamic map) of an emergency situation. The map may include locations of the RFID devices (e.g., first responders) as well as environmental data overlays, such as gas level indicators, temperature indicators, hazardous or high-risk area indicators, etc. In this way, data gathered from first responders can be quickly processed to provide maps and other actionable information that may be provided to incident commanders or other team coordinators during an emergency. Consequently, the team leaders are provided with greater amounts of up-to-date situational information while an emergency occurs, enabling informed decision making to take place. For instance, dynamic gas-level map overlays may be provided to incident commanders to enable the commanders to guide on-site first responders from low visibility and high-risk areas in a fire to a higher visibility and lower risk area. More generally, the server may generate a representation of the sensor data signal in the map or other suitable graphical user interface. For instance, a temperature overlay may be provided. Furthermore, the map may be a 3-dimensional map indicating vertical coordinates of objects presented on the map. It will be appreciated that the vertical coordinates are made possible via sensor reading gathered via the UAV.

Next at 412 the method includes presenting the map of the emergency situation on a display of the server. In one example, the method may further include generating an alert based on the environmental sensor data and sending the alert to the RFID devices. For instance, an alert may be generated when it is determined that one or more of the RFID devices is located within a high-risk area. In this way, personnel carrying the RFID devices or near the RFID device may be notified when they are in a high-risk zone, for example.

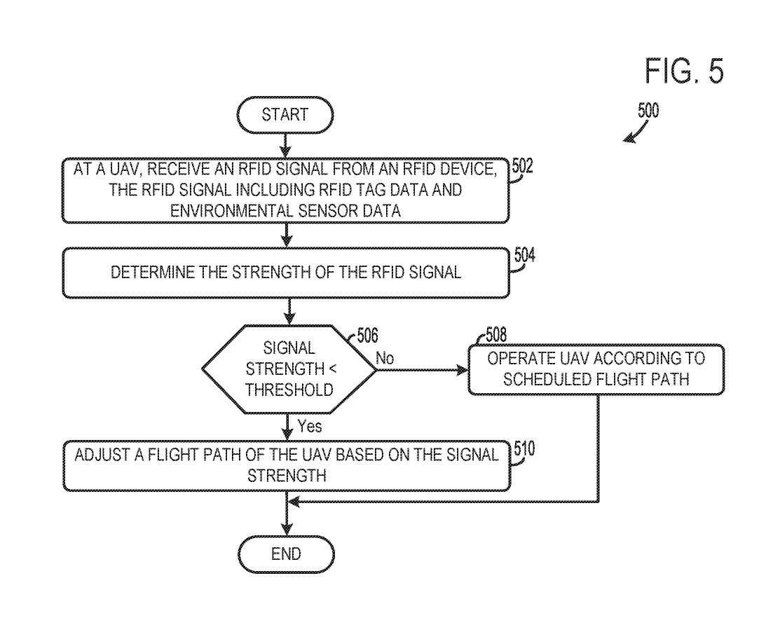

FIG. 5 shows a method for controlling operation of a UAV in an aerial RFID tracking and data collection system. The method may be implemented by the aerial RFID tracking and data collection system and corresponding devices, components, etc., described above with regard to FIGS. 1-3 or may be implemented by other suitable aerial RFID tracking and data collection systems.

At 502 the method includes, at a UAV, receiving an RFID signal from an RFID device, the RFID signal including RFID tag data and environmental sensor data. Next at 504 the method includes determining the strength of the RFID signal.

At 506 the method includes determining if the signal strength is less than a threshold value. The threshold value may be determined using an expected range at which the UAV can reliably gather data from the RFID device. For instance, the UAV may be designed to reliably gather RFID signals which are less than 400 feet away from the UAV. The signal strength from the RFID device may indicate that the RFID device is 350 feet away. As such it may be determined that the signal strength is not below threshold value. However, other techniques for determining signal strength thresholds have been contemplated.

If it is determined that the signal strength is not less than the threshold value (NO at 506) the method proceeds to 508. At 508 the method includes operating the UAV according to a scheduled flight path.

On the other hand, if it is determined that the signal strength is less than the threshold value (YES at 506) the method proceeds to 510. At 510 the method includes adjusting a flight path of the UAV based on the signal strength. For instance, the flight path of the UAV may be changed to decrease the distance between the UAV and the RFID device to enable the UAV to pick up a more reliable signal from the RFID device. Method 500 enables the route of the UAV to be dynamically adjusted to improve the data gathering capabilities of the UAV. As a result, more reliable and up-to-date maps of an emergency situation can be generated by the server.

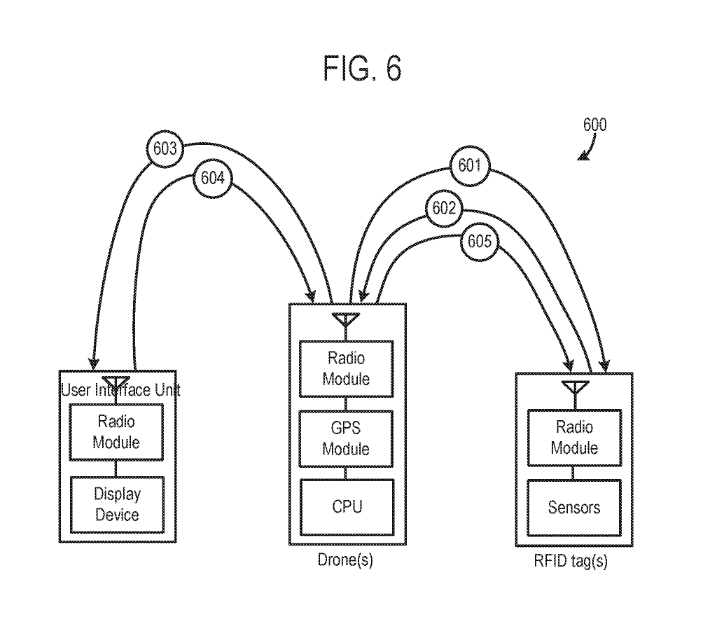

FIG. 6 shows a method 600 for gathering and managing data in a data collection system. The data collection system is illustrated as including a user interface unit, one or more drones, and one or more RFID tags. The user interface unit includes a radio module and display device. Additionally, the drones include radio modules, GPS modules, and a processor. The RFID tags also include radio modules and sensors. It will be appreciated that the user interface unit, drones, and/or RFID tags may include any of the components previously described with regard to FIGS. 1-3. Further, in one example, it will be appreciated that the user interface unit may include features, components, functions, etc., of the communication head 16 and/or the server 18 described above with regard to FIGS. 1-3. For instance, the user interface unit may include a processor, memory, display, etc.

At 601 the method includes, at the drones, periodically scanning for RFID tags and requesting information such as sensor data. The scanning may be carried out via an antenna in the radio module on-board the drone. Next at 602 the method includes, at the RFID tags, in response to the information request, sending tag ID and the requested data to the drones.

At 603 the method includes, at the drones, reporting the RFID tag data along with the GPS location corresponding to the location where the RFID tag was read. Next at 604 the method includes, at the user interface unit, sending information such as messages or settings to the drones. At 605 the method includes, at the drones, forwarding the information to the appropriate RFID tags. The settings sent to the drones and the RFID tags may trigger alerts (e.g., audio, visual, and/or haptic alerts) at the RFID tags and/or adjustments in the flight path of the drones, in one example. Method 600 enables tag and sensor data to be efficiently gathered by the drones and relayed to the user interface unit that in-turn quickly processes the data and forwards settings and/or messages to the RFID tags.

FIG. 7 shows an example of a display 700 on which a GUI 702 is presented. The display 700 is an example of the display 52, shown in FIGS. 1 and 3 and the GUI 702 is an example of the GUI 302, shown in FIG. 3. However, it will be appreciated that the server 18, shown in FIGS. 1 and 3 may be designed to generate numerous GUIs representing environmental sensor data, location data, RFID tag data, etc., gathered from the land-based RFID devices and/or the UAVs in the system.

Continuing with FIG. 7, the GUI 702 is in the form of an elevated view map. However, it will be appreciated that the GUI 702 may also present a perspective view and/or a horizontal view. Specifically, the view of the map may indicate a vertical positon of objects, sensor readings, etc. For instance, the view may indicate building floors, in a scenario where an emergency situation occurs in a multi-story building. However, it will be appreciated that numerous suitable map configurations have been envisioned.

The GUI 702 includes geographical objects 706 (e.g., roads, buildings, bodies of water, etc.). Additionally, land-based RFID devices 708 are shown in FIG. 7. The land-based RFID device positions may be determined via sensors onboard the UAV and/or in the RFID devices 708. A high-risk area 710 is also presented in FIG. 7. The high-risk area 710 may indicate a dangerous area for emergency responders. For example, the area may have elevated gas levels and/or temperature levels posing a danger to humans in the area. As previously, discussed the high-risk area may be determined based on a gas level threshold, a temperature level threshold, and/or a comparison between gas and temperature levels in the area. Further in one example, the navigational path of the UAV may be adjusted based on the high-risk area. For instance, the UAV may be directed around the high-risk area to reduce the likelihood of damage to the UAV. However, in other examples, the UAV may be directed into the high-risk area to obtain more granular sampling via the onboard environmental sensors. Additionally or alternatively, dynamic gas and/or temperature level maps may be presented on the GUI indicating the temperature and/or gas levels around the emergency area.

Furthermore, the land-based RFID devices 708, high-risk area 710, etc., may be presented as map overlays, in one example. Further, in some examples, the high-risk area 710 may segmented in terms of risk gradients. Such gradients may also be applied to temperature sensor data and/or gas sensor data. In this way, the granularity of situational data provided to emergency responders or other incident personnel may be increased. It will be appreciated that the GUI 700 shown in FIG. 7 provides personnel such as incident commanders, first responders, etc., with pertinent situational information facilitating informed decision making while an emergency occurs.

The invention will further be described in the following use-case examples. The use-case examples are provided to illustrate the applicability of the systems and methods, described above, to a variety of different scenarios.

In a first use-case example, a group of firefighters are dispatched to a burning building. Each of the firefighters in the group carries an RFID device including an active RFID transmitter tag and a temperature sensor. Additionally, when the firefighters arrive on scene they deploy a UAV equipped with an RFID receiver. Subsequent to UAV dispatch, the firefighters travel to different floors of the building. The UAV may then fly in patterns around the building while scanning the RFID transmitter tags carried by the firefighters. The UAV then appends location data to the RFID and temperature sensor data and relays this data package to a central server. The server then leverages the data package to create dynamic maps with real-time locations of first responder with overlays showing dynamic gas and temperature data. The maps may also include a vertical location of the firefighters with regard to floors of the burning buildings. Hazardous and low visibility areas in the burning building, determined based on comparisons between sensor signals, may also be presented in the maps. Furthermore, the maps may be viewed by incident commanders or the first responders, enabling firefighting personnel to make informed decisions during a crisis situation.

In a second use-case example, a UAV may be flown around a wildland fire zone. Wildland firefighters working in the fire zone may each carry an RFID device. A team leader may deploy a UAV when the team branches off to perform different fire suppression tasks. After deployment, the UAV scans for the signals from the RFID transmitters. The UAV may pick up RFID tag signals from the RFID devices and append location information to the tag data to enable the server to generate a map of the fire zone with real-time locations of the firefighters as well as temperature and toxic gas (e.g., carbon monoxide) level overlays. The server may then transfer the map to a fire chief and/or the firefighters in the crew. The fire chief would then be able to rapidly make critical decisions regarding the position and efforts of the crew in order to increase (e.g., maximize) crew effectiveness and safety. Furthermore, once the RFID signals are picked up, the flight path of the UAV may be adjusted to prevent the signals from being dropped by the UAV. For instance, maximum signal ranges of targeted RFID devices may be determined when the RFID signals are first picked up by the UAV. The UAV may be subsequently flown such that the maximum ranges are not surpassed.

As described herein a processor may include a device with one or more central processing units (CPUs) and/or graphics processing units (GPUs), for example. Additionally, memory may include semiconductor memory (e.g., RAM, EPROM, EEPROM, etc.), volatile, nonvolatile, dynamic, static, read/write, read-only, random-access, sequential-access, location-addressable, file-addressable, and/or content-addressable devices, etc. Thus, the memory described herein may be non-transitory memory. The mass storage described herein may include devices such as magnetic memory (e.g., (e.g., hard-disk drive, MRAM, etc.), flash memory, etc. It will be appreciated that the configurations of each processor, memory, and/or mass storage described herein may vary based on the desired device functionality. For instance, the server may include a more powerful processor than the RFID devices. It will also be appreciated that some of the devices herein may include processors, memory, and/or mass storage having similar designs, in some instances. The processors, memory, and mass storage may each include one or more physical devices. However, aspects of the instructions described herein alternatively may be propagated by a communication medium (e.g., an electromagnetic signal, an optical signal, etc.,) that is not held by a physical device for a finite duration. Additionally, the displays described herein may include one or more display devices utilizing virtually any type of technology allowing for the presentation of a visual representation of data held in the memory. This visual representation may take the form of a GUI. As the herein described methods and processes alter the data held by the memory, and thus transform the state of the memory and the state of the displays.

The invention will further be described in the following paragraphs. In one aspect, an aerial radio-frequency identification (RFID) tracking and data collection system is provided that includes a server including; a communication interface designed to send and receive data from an unmanned aerial vehicle (UAV); computer readable instructions stored in non-transitory memory that when executed cause a processor to; receive a data bundle including environmental sensor data and an RFID tag identifier from the UAV, where the RFID tag identifier and temperature sensor data in the environmental sensor data are generated by a land-based RFID device in wireless communication with the UAV; and generate a graphical user interface including a representation of the environmental sensor data.

In another aspect, a method for operating an aerial radio-frequency identification (RFID) tracking and data collection system is provided that includes at a server, receiving a data bundle including temperature sensor data and RFID tag data generated by a land-based RFID device and relayed through an unmanned aerial vehicle (UAV), where the temperature sensor data indicates an ambient temperature near the land-based RFID device; appending gas sensor data to the data bundle at the UAV, where the gas sensor data indicates a gas level near the UAV; and generating a graphical user interface including a representation of the temperature sensor data, the RFID tag data, and the gas sensor data. In one example, the method may further include at the server, when at least one of the temperature sensor data and the gas sensor data exceed a corresponding threshold value, generating a high-risk area overlay in the graphical user interface. In another example, the method may further include, at the UAV, combining the gas sensor data with the temperature sensor data and the RFID tag data to form the data bundle.

In any of the aspects or combinations of the aspects, the environmental sensor data may include gas sensor data generate by a gas sensor in the UAV and where the server further comprises computer readable instructions stored in the non-transitory memory that when executed cause the processor to; generate a dynamic map overlay indicating a high-risk area based on the gas sensor data and the temperature sensor data; where the dynamic map overlay is included in the representation of the environmental sensor data.

In any of the aspects or combinations of the aspects, the server may further comprise computer readable instructions stored in the non-transitory memory that when executed cause the processor to generate an alert based on the environmental sensor data and send the alert to the land-based RFID device through the UAV.

In any of the aspects or combinations of the aspects, the alert may be generated when the temperature sensor data indicates a temperature around the land-based RFID device exceeds a corresponding threshold value.

In any of the aspects or combinations of the aspects, the representation of the environmental sensor data may include a dynamic gas level map that is generated based on gas sensor data included in the environmental sensor data, where the gas sensor data is received from the UAV while the UAV travels along a predetermined flight path, and where the gas sensor data is generated by a gas sensor included in the UAV.

In any of the aspects or combinations of the aspects, the server may further comprise computer readable instructions stored in the non-transitory memory that when executed cause the processor to generate a location of the land-based RFID device within a map including the representation of the environmental sensor data and where the land-based RFID device is affixed to a first responder and the location includes a vertical coordinate and a plurality of horizontal coordinates.

In any of the aspects or combinations of the aspects, the vertical coordinate may include a building floor value.

In any of the aspects or combinations of the aspects, the aerial RFID tracking and data collection system may further comprise the UAV including; a motor receiving energy from an energy storage device; a rotor or propeller receiving energy from the motor; a RFID receiver configured to receive wireless RFID signals; and computer readable instructions stored in UAV non-transitory memory that when executed cause a UAV processor to; receive an RFID signal from an RFID transmitter tag in the land-based RFID device and where the RFID signal includes the RFID tag identifier and the temperature sensor data; append location data and gas sensor data included in the environmental sensor data to the RFID signal to form the data bundle; and transfer the data bundle to the server through a communication head.

In any of the aspects or combinations of the aspects, the UAV may further comprise computer readable instructions stored in the UAV non-transitory memory that when executed cause the UAV processor to adjust a flight path of the UAV based on a signal strength of the RFID signal generated by the land-based RFID device.

In any of the aspects or combinations of the aspects, the land-based RFID device may be affixed to a first responder or a stationary object.

In any of the aspects or combinations of the aspects, the data bundle may include location data indicating a location of the land-based RFID.

In any of the aspects or combinations of the aspects, the location data may include a vertical coordinate.

In any of the aspects or combinations of the aspects, the representation of the temperature sensor data, RFID tag data, and the gas sensor data may include a dynamic map overlay.

In any of the aspects or combinations of the aspects, the high-risk area overlay may be generated when both the temperature sensor data and the gas sensor data exceed a corresponding threshold value.

In any of the aspects or combinations of the aspects, the dynamic map overlay indicating the high-risk area may be generated when at least one of the temperature sensor data and the gas sensor data exceed a corresponding threshold value.

In any of the aspects or combinations of the aspects, a boundary of the high-risk area may be expressed in terms of horizontal coordinates.

In any of the aspects or combinations of the aspects, the boundary of the high-risk area may be expressed in terms of vertical coordinates.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An aerial radio-frequency identification (RFID) tracking and data collection system comprising:
a server including;
a communication interface designed to send and receive data from an unmanned aerial vehicle (UAV);
computer readable instructions stored in non-transitory memory that when executed cause a processor to;
receive a data bundle including environmental sensor data and an RFID tag identifier from the UAV, where the RFID tag identifier and temperature sensor data in the environmental sensor data are generated by a land-based RFID device in wireless communication with the UAV; and
generate a graphical user interface including a representation of the environmental sensor data.

2. The aerial RFID tracking and data collection system of claim 1, where the environmental sensor data includes gas sensor data generate by a gas sensor in the UAV and where the server further comprises computer readable instructions stored in the non-transitory memory that when executed cause the processor to;
generate a dynamic map overlay indicating a high-risk area based on the gas sensor data and the temperature sensor data;
where the dynamic map overlay is included in the representation of the environmental sensor data.

3. The aerial RFID tracking and data collection system of claim 1, where the server further comprises computer readable instructions stored in the non-transitory memory that when executed cause the processor to generate an alert based on the environmental sensor data and send the alert to the land-based RFID device through the UAV.

4. The aerial RFID tracking and data collection system of claim 3, where the alert is generated when the temperature sensor data indicates a temperature around the land-based RFID device exceeds a corresponding threshold value.

5. The aerial RFID tracking and data collection system of claim 1, where the representation of the environmental sensor data includes a dynamic gas level map that is generated based on gas sensor data included in the environmental sensor data, where the gas sensor data is received from the UAV while the UAV travels along a predetermined flight path, and where the gas sensor data is generated by a gas sensor included in the UAV.

6. The aerial RFID tracking and data collection system of claim 1, where the server further comprises computer readable instructions stored in the non-transitory memory that when executed cause the processor to generate a location of the land-based RFID device within a map including the representation of the environmental sensor data and where the land-based RFID device is affixed to a first responder and the location includes a vertical coordinate and a plurality of horizontal coordinates.

7. The aerial RFID tracking and data collection system of claim 6, where the vertical coordinate includes a building floor value.

8. The aerial RFID tracking and data collection system of claim 1, further comprising the UAV including;
a motor receiving energy from an energy storage device;
a rotor or propeller receiving energy from the motor;
a RFID receiver configured to receive wireless RFID signals; and
computer readable instructions stored in UAV non-transitory memory that when executed cause a UAV processor to;
receive an RFID signal from an RFID transmitter tag in the land-based RFID device and where the RFID signal includes the RFID tag identifier and the temperature sensor data;
append location data and gas sensor data included in the environmental sensor data to the RFID signal to form the data bundle; and
transfer the data bundle to the server through a communication head.

9. The aerial RFID tracking and data collection system of claim 8, where the UAV further comprises computer readable instructions stored in the UAV non-transitory memory that when executed cause the UAV processor to adjust a flight path of the UAV based on a signal strength of the RFID signal generated by the land-based RFID device.

10. A method for operating an aerial radio-frequency identification (RFID) tracking and data collection system, comprising:
at a server, receiving a data bundle including temperature sensor data and RFID tag data generated by a land-based RFID device and relayed through an unmanned aerial vehicle (UAV), where the temperature sensor data indicates an ambient temperature near the land-based RFID device;
appending gas sensor data to the data bundle at the UAV, where the gas sensor data indicates a gas level near the UAV; and
generating a graphical user interface including a representation of the temperature sensor data, the RFID tag data, and the gas sensor data.

11. The method of claim 10, where the land-based RFID device is affixed to a first responder or a stationary object.

12. The method of claim 10, where the data bundle includes location data indicating a location of the land-based RFID.

13. The method of claim 12, where the location data includes a vertical coordinate.

14. The method of claim 11, where the representation of the temperature sensor data, RFID tag data, and the gas sensor data includes a dynamic map overlay.

15. The method of claim 11, further comprising, at the server, when at least one of the temperature sensor data and the gas sensor data exceed a corresponding threshold value, generating a high-risk area overlay in the graphical user interface.
